(19) United States
(12) Patent Application Publication
(10) Pub. No.: US 2004/0210433 A1
(43) Pub. Date: Oct. 21, 2004

(54) System, method and apparatus for emulating a web server

(76) Inventors: Gidon Elazar, Tzur Igal (IL); Dan Harkabi, Moshav Lachish (IL); Nehemiah Weingarten, Tel-Aviv (IL)

Correspondence Address: Nehemiah Weingarten (MDRM Inc), PO BOX 13, KIBBUTZ EINAT, 49910, IL

(21) Appl. No.: 10/827,267

(22) Filed: Apr. 20, 2004

Related U.S. Application Data
(60) Provisional application No. 60/464,024, filed on Apr. 21, 2003.

(51) Int. Cl. G06F 9/455

(52) U.S. Cl. 703/24

(57) ABSTRACT

Various embodiments include a system, method and apparatus for providing web pages and content using a storage device, such that the web pages and content are accessed offline. The information and programs that compose the web page are stored in the storage within the device (hereafter Web Server Emulation Device). The Web Server Emulation Device connects to a computing device (hereafter Client Digital Appliance) such as a personal computer, which executes a proxy program. The Client Digital Appliance may also execute a web-browsing program. The proxy captures web browser requests and processes them. If required, the proxy program transfers part or all of a request to the Web Server Emulation Device for further processing. The Web Server Emulation Device may also store user input, such as from an HTML form, to be transmitted to a remote web server when connected to a network such as the Internet.

### RELATED U.S. APPLICATIONS

This application claims the benefit of provisional patent applications serial No. 60/464,024, filed Apr. 21, 2003.

This application is related to patent application Ser. No. 10/227,155 filed Aug. 23, 2002.

### FIELD OF THE INVENTION

The present invention relates to delivery of web pages and other digital content, and more particularly the use of a local device with storage capacity to deliver web pages and content to a rendering device that may or may not be connected to a network such as the Internet.

### BACKGROUND OF THE INVENTION

The Internet World Wide Web implements a client/server model to transfer information from web servers to web clients and vice versa. A Web server is a program that serves web pages as well as other types of content to users running client software known as web browsers. A web page is a document, usually written in Hypertext Markup Language (HTML), that can be accessed on the Internet. Web pages can contain information, graphics, and hyperlinks to other Web pages and files. Web pages may be displayed on a client computing device (hereafter Client Digital Appliance) such as PC, laptops, PDA, mobile phone and any other computational device that can connect to the Internet.

Examples of web servers are Apache, Microsoft's Internet Information Server (IIS), Novell's Web Server, and IBM's family of Lotus Domino servers. Examples of popular web client software (also called web browsers) are Microsoft Internet Explorer and Netscape Navigator. Generally a web server or a collection of web servers provide and/or create and/or transmit over the Internet the information required by the browser to compose and render a requested web page. Therefore in order to retrieve information from a web server, the Client Digital Appliance must be connected to the Internet. The main protocol used to format these requests and responses is called the Hypertext Transfer Protocol (HTTP).

The content sent to the browser can be of several types and formats. It can be static, such as a text file or an image file; HTML (Hyper Text Markup Language) is frequently used to describe static information on a web page. Other types can be streamed data, such as video and audio, which are transmitted as a stream composed of chunks of information, then processed and rendered as received. Another type of information can be a file such as text, video, audio, games, programs, Java applets, or ActiveX controls, all of which may be downloaded from web server to client. Still another format can be user-input dependant and is determined by information sent from client to server, for example a “search” command requested by the client triggers a process in the server to dynamically produce the information to be rendered.

In some cases data is sent from the client to the server for further processing. For example when a user fills out a form on a web page and sends it back to the server. The web server typically passes the form's information to an application program that processes the data. A confirmation message, more forms, and/or more content may be sent to the client as a result. One method or convention for passing data back and forth between the server and the client is called the common gateway interface (CGI) and is part of the World Wide Web's Hypertext Transfer Protocol (HTTP). Microsoft's proprietary interface method is known as an Active Server Page (ASP). Typically, the script in the web page at the server uses input received as the result of the users request for the page to access data from a database and then builds or customizes the page on the fly before sending it to the requester.

In order to personalize the web browsing experience, web-servers use cookies. A cookie is information for future use that is stored by the web server on the client side of a client/server communication, and is usually stored on a user's hard disk. Typically, a cookie records user preferences when using a particular site. Using HTTP, each request for a web page is independent of all other requests. For this reason, the web server has no memory of what pages it has previously sent to a user or anything about a user's previous visits to the server website. A cookie is a mechanism that allows the server to store its own information about a user on the user's own computing device. Generally, cookies are tied to a specific browser on a specific computer.

There are several shortcomings to online web browsing. First, users must be connected to the Internet to browse web pages online, and the Internet connection may not always be available or perhaps not economically feasible.

Second, even if the connection is available, an online session may not be fully utilized if during a connection, communication between server and client is happens infrequently, as will be shown in the following example. Many web servers offer users an interactive experience, such as filling in HTML forms, searching a database, shopping, or taking a test. An HTML form is an HTML page which passes variables back to the server. HTML forms are used to gather information from users. When filling in an HTML form, the user may need from several seconds to several hours to complete the detatils. In case of the latter, being connected to the Internet while filling in the information onto a HTML form does not entail any communications between server and browser, the transfer of data is executed only when the user has finished filling in the form. Therefore being connected throughout the stage of filling in the form might not be economical.

Third, many dial-up Internet connections transfer data at a slow rate, which means long waits for some types of web pages to load, especially pages with graphics and other memory intensive content. Other waits may be due to downloading of content such as audio or video files.

Existing art attempts to solve the aforementioned problems by providing users with offline versions of a website. The most obvious is the ability to save web pages onto a local hard drive for future use. Another example is that of CDs that are preloaded with web content and sent by postal mail to users. In the simplest form, the CD is filled with web pages as well as other content. The user selects a URL (Unified Resource Locator) pointing to the CD and views the relevant page. Usage examples are catalogs, price lists, manuals, instruction guides, restricted corporate information, picture galleries and the like.

However, this solution is not satisfactory for many web pages that need to be dynamically created. These web pages are created based on some sort of input from the user and require some computation by the web server to be created. A CD has no computational capability. To overcome this limitation, some CD solutions provide an application program to be executed on the computer running the web browser. The application program functions as a server emulator that enables the creation of dynamic web pages based on user input. Examples are Verity's Publisher (http://www.veiity.com/products/publisher/index.html), and PHDCC Dynamic CD (http://www.phdcc.com/dynamic-cd).

Unfortunately these solutions create only a partial emulation of a web server. The server emulation is executed on the client PC, hence the web server processes, databases, and information are within the access of the user. In a true online client/server scenario, part of the data and programs on the server are not accessible by the client. Advantages of this are ensuring content integrity, non-disclosure of content in ways the content provider did not have in mind, and the esthetic advantage of hiding the frequently cluttered internal structure and files of the web page from the client.

Moreover, when using a CD as a web server, user information created through user interaction with web pages, such as cookies, cannot be stored on the CD. To overcome this, the information is stored on the computer hard disk, but this solution degrades the ability for the user to later browse on a different computer.

Moreover, a CD cannot record user-generated input, such as data entered through a form, or a test taken by the user. This information might be recorded on the user's computer hard drive, again degrading its portability. For instance it would be beneficial for a student to take a test on an offline or Internet dial up home computer, fill and submit the form offline, then connect to the Internet using a school computer, perhaps with faster communications in order to transmit the submitted test.

Additionally, CDs are cumbersome and fragile compared to smaller storage devices such as USB Flash Drives and Flash Storage Cards.

Furthermore, CDs cannot be updated as they are a write-once-read-many media type. In order to provide a client with updated content, the content provider must send a new CD via postal mail each time the web server content is updated.

Still further, CDs may be duplicated, thus allowing access to information to more people than perhaps was originally intended by the content provider.

There is clearly an unmet need for a solution to offline web-page viewing that enables hiding of part or all the components of the web page and other content, enables updating the content via a network, and enables portability across client devices.

### SUMMARY OF THE INVENTION

The above-mentioned disadvantages and problems are addressed by the present invention, which will be understood by reading the following specification.

According to the present invention, the information and algorithms for emulating a web server, or part of them, are stored and optionally executed in a dedicated Web Server Emulation Device that has processing capability distinct from the Client Digital Appliance to which it is connected. In some embodiments, the Web Server Emulation Device is a small portable storage device such as a USB Flash Drive or other removable Flash storage media.

According to some embodiments, a file or plurality of files and/or a database or a plurality of databases (altogether hereafter Website files) are transferred from an Internet server to the Web Server Emulation Device through a client device. According to other embodiments, the Website files are already resident in the Web Server Emulation Device. Once the Website files are internal to the device, several processes may take place.

In some embodiments, a Middleware is executed in the Client Digital Appliance and serves as a proxy between the web browser program executing on the same Client Digital Appliance and the Web Server Emulation Device. The Middleware may process web browser requests, for example HTTP requests.

In some embodiments, the Middleware may partially process the web browser request, and then communicate with the Web Server Emulation Device for further processing of the request and/or for the retrieval of information.

According to some embodiments, the web browser may send user input to the Middleware, which may then process it or partially process it and then forward the input or processed input to the Web Server Emulation Device for further processing and/or archiving for future use.

According to some embodiments, the Web Server Emulation Device may store personalization information regarding the user of the device, or the usage of the web pages stored in the device, the client devices, and/or any other information unique to the particular device or its usage.

According to some embodiments, the archived user input and/or the personalized information may be sent from the Web Server Emulation Device through a Client Digital Appliance to a remote web server over a network, for example the Internet network, for further processing and/or archiving.

According to some embodiments, in order to maintain a separation between user accessible components and user-restricted components, the web server emulation program executes partially executes on a Web Server Emulation Device that has some form of computational power.

According to some embodiments, the storage area inside the Web Server Emulation Device is partitioned into a user accessible section and a hidden-from-user section where part of the processes and data of the emulated web server are located.

According to some embodiments, in order to enable portability of the offline web pages and content, status information such as cookies and user input can be stored in the Web Server Emulation Device storage area. This enables the offline website to be used with a plurality of computers. Status information can be stored in the Web Server Emulation Device's hidden-from-user section in order to maintain integrity of content and status information.

### BRIEF DESCRIPTION OF THE DRAWINGS

The foregoing and other objects, aspects, and advantages will be better understood from the following description of an embodiment of the invention with reference to the drawings, wherein:

FIG. 1 is a schematic block diagram of an exemplary embodiment of the Web Server Emulation Device.

FIG. 2 is a schematic block diagram of an exemplary system.

FIG. 3 is a flow chart of an exemplary offline browsing session.

FIG. 4 is a flow chart of an exemplary offline session archiving user input.

FIG. 5 is a flow chart of an exemplary online synchronization process.

FIG. 6 is a flow chart of another exemplary online synchronization process.

### DESCRIPTION OF THE INVENTION

In the following description of exemplary embodiments of the invention, reference is made to the drawings that illustrate specific exemplary embodiments in which the invention may be practiced. Those skilled in the art will appreciate that other embodiments may be utilized without departing from the spirit of the present invention; therefore the following detailed description of the invention should not be taken in a limiting sense. In various embodiments, there may be none, one, or more than one of the following described parts.

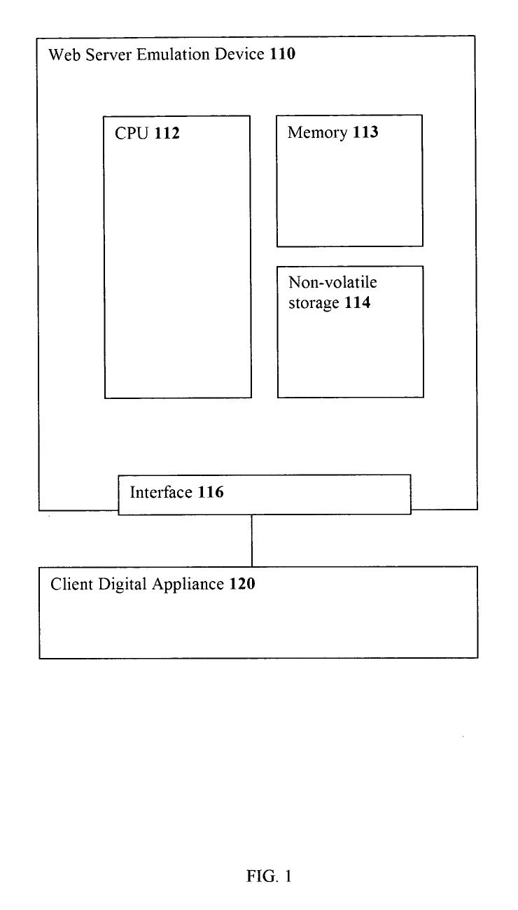

FIG. 1 is a diagram of an exemplary embodiment of the Web Server Emulation Device 110, which includes a central processing unit (CPU) 112, an optional system memory 113, non-volatile storage 114, and an interface 116 to connect the Web Server Emulation Device 110 to a Client Digital Appliance 120. There may be only one or a plurality of CPU 112. There may optionally be only one or a plurality of system memory 113 or non-volatile storage 114. There may be only one or a plurality of interfaces 116, the invention is not so limited. The non-volatile storage 114 may be included in the CPU 112 or be discrete from the CPU 112. Generally, components or subcomponents of the Web Server Emulation Device 110 may be combined with other components or subcomponents of the Web Server Emulation Device 110 for higher integration and perhaps lower cost.

The CPU 112 may be a general purpose CPU or a CPU with dedicated functions. Furthermore the CPU 112 may include internal memory, and internal non-volatile storage, which in the description of the present invention may serve a similar purpose of the system memory 113, and non-volatile storage 114 respectively. The CPU 112, the non-volatile storage 114, and/or other components may be implemented as a tamper resistant hardware, or sections of the CPU 112, the non-volatile storage 114, and/or other components may be tamper resistant, the invention is not so limited.

The non-volatile storage 114 may be any of several types of storage including semiconductor based media such as read only memory (ROM), electronic erasable programmable read only memory (EEPROM), flash memory, or battery backed up random access memory (RAM) or the like, or magnetic media storage such as a micro-drive (www.hgst.com/products/microdrive/) or any other type of non-volatile storage, the invention is not so limited.

The non-volatile storage 114 contains instructions that may be executed by the CPU 112. The non-volatile storage 114 may further contain a storage area for digital files. A digital file is data that is stored and/or represented in numerical form.

In various embodiments, Client Digital Appliance 120 may be a personal computer, laptop computer, tablet computer, Personal Digital Assistant (PDA), mobile phone, gaming console or any other computing device with an interface that can be coupled to the Web Server Emulation Device 110, the invention is not so limited.

The interface 116 can connect the Web Server Emulation Device 110 with a Client Digital Appliance 120 in both physical and communication aspects. The physical aspect can be, for example directly, or through one or more cables, and/or in a wireless manner. The communication aspect of the interface 116 allows data exchange between the Web Server Emulation Device 110 and the Client Digital Appliance 120. The interface 116 may be any of several types of interfaces, for example Universal Serial Bus (USB), FireWire, RS-232 or another serial interface, parallel interface, Compact Flash (CF) interface, Sony Memory Stick interface, Multimedia Card (MMC), secure digital (SD), mini SD, Extreme Digital (xD), Bluetooth, WiFi, ultrawideband, Infiniband, and/or any other type of interface that may be used to connect a Web Server Emulation Device with a client device, the invention is not so limited.

The Client Digital Appliance 120 is used by an end user for some end use, such as web content retrieval from a remote computational device and/or from the Web Server Emulation Device 110.

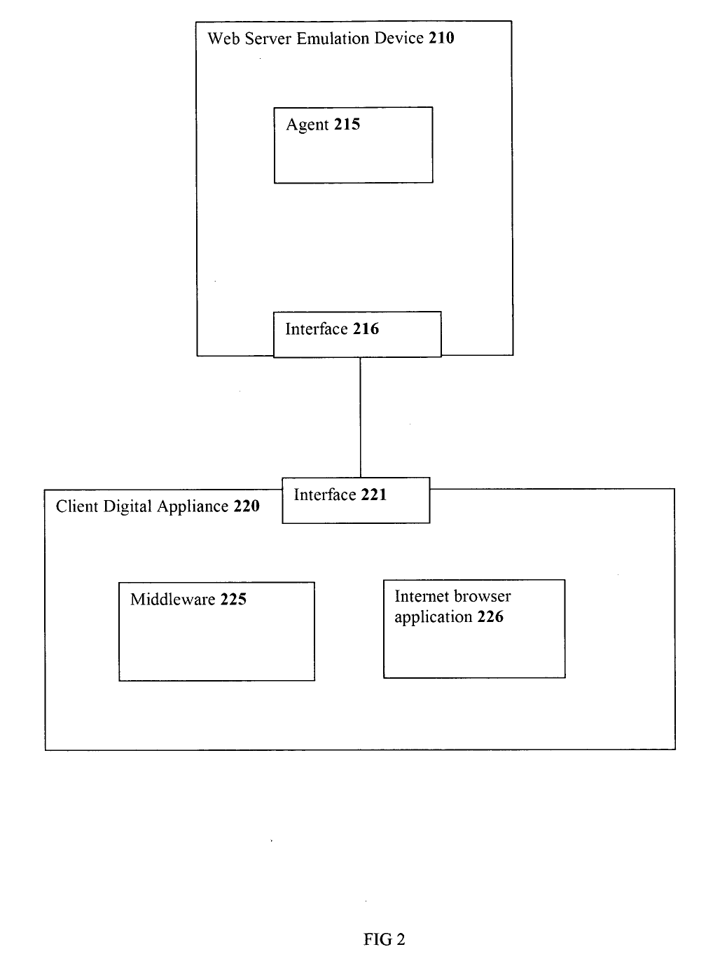

FIG. 2 is an exemplary embodiment of the system, including a Web Server Emulation Device 210 with interface 216. Client Digital Appliance 220 has an interface 221 matching to interface 216. The Web Server Emulation Device 210 contains an Agent 215 software code that emulates or partially emulates the behavior of an Internet server. The Client Digital Appliance 220 contains a Middleware 225 software code that dispatches requests to the Agent 215 and gathers responses from the Agent 215. In some embodiments the Middleware 225 processes or partially processes the requests to the Agent 215 and/or the responses from the Agent 215. Requests may originate by user action, for example as result of interaction with a software application, such as an Internet browser, or initiated by other software components executing on Client Digital Appliance 220.

In some embodiments, Middleware 225 captures requests issued by the Internet browser application 226, such as HTTP requests to receive web page information. The Middleware 225 processes or partially processes the captured request and sends one or more requests through interface 216 to an Agent 215 in the Web Server Emulation Device 210. An Agent 215 in the Web Server Emulation Device 210 can process requests from a Middleware 225 and respond to such requests.

In some embodiments the Middleware 225 issues requests to the Agent 215 to access data in the non-volatile storage of the Web Server Emulation Device 210. In some embodiments, the non-volatile storage may be divided into a user storage area and a hidden storage are. The Agent 215 may access data either in the hidden storage area or the user storage area. In some embodiments, the data retrieved by the Agent 215 is forwarded to the Middleware 225 as a response or part of a response to the request issued by the Middleware 225. In other embodiments, the retrieved data is used as a basis for processing and determining the appropriate response. It may be appreciated by those skilled in the art that other alternatives of how an Agent 215 may be used the retrieved data may exist.

In some embodiments, the Middleware 225 makes itself accessible to other programs executing on the Client Digital Appliance 220, for example an Internet browser application 226, by registering as a network node, with its own TCP/IP address and/or communication port. For example, in some embodiments the Middleware 225 may identify itself using an address range 127.0.0.x (x is a value forming a valid address) which in many computer systems is defined as the loopback address range, an address local to the computer. Additionally, the emulation may identify itself as port 80 on that address, which is the standard HTTP port that is referred to by default by Internet browsing programs. In some embodiments, the Middleware 225 identifies itself with the TCP/IP address of the Client Digital Appliance 220, or with any other address and/or port, or with no address, the invention is not so limited.

In some embodiments, once the Middleware 225 is identified with a TCP/IP address, the Internet browser application 226 can be directed to browse a URL that resolves to the defined TCP/IP address and/or communication port. In such a case, all requests issued by the Internet browser application 226 are directed to the Middleware 225, which may capture and manage an appropriate response. In some embodiments, Middleware 225 will communicate the Agent 215 to produce or partially produce the response. In other embodiments, the Middleware 225 may respond to an Internet browser 226 request without accessing the Agent 215.

In may be appreciated by those skilled in the art that there are additional methods to make Middleware 225 available to other programs executing on Client Digital Appliance 220, the invention is not so limited.

In some embodiments, the Agent 215 and/or Middleware 225 respond to requests for HTTP messages, such as generated by Internet browser 226. In other embodiments, the Agent 215 and/or Middleware 225 respond to other types of requests that are commonly responded to by web servers, such as FTP, NFS, email request such as MAPI, POP mail, SNMP, data streaming, content streaming and the like protocols or any combination of the above, this invention is not so limited.

In some embodiments, the Middleware 225 may also respond to local API (Application Program Interface) requests received from an application without the use of a web server protocol.

The Middleware 225 may respond to requests initiated locally on the Client Digital Appliance 220 or on a remote computational device, in such cases when the Client Digital Appliance 220 is connected to a network, such as the Internet network.

It may be appreciated by those skilled in the art that the Middleware 225 may be implemented in a variety of forms, for example, as one program, as a plurality of programs, as a module within a program and the like, and that there exist a variety of ways for the Middleware 225 to capture requests without departing from the spirit of this invention.

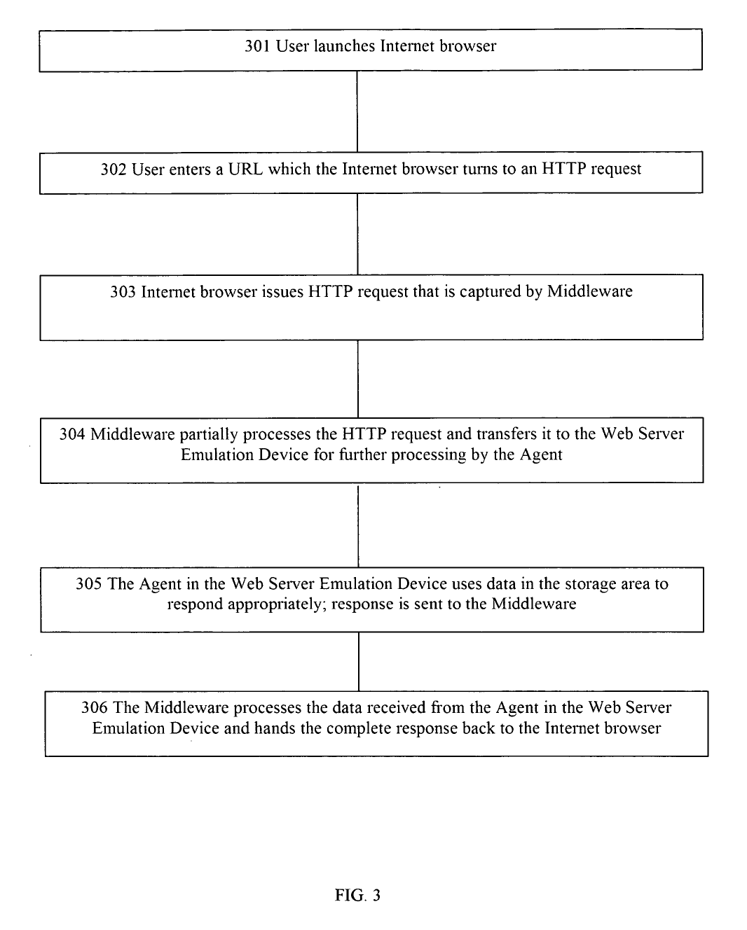

FIG. 3 is a flow chart describing an exemplary sequence of operations carried out when a user browses a web site using the Web Server Emulation Device 210. In step 301 the user launches a web browsing application, for example Microsoft Internet Explorer, on the Client Digital Appliance 220.

In step 302 the user enters a URL that directs the browser to the Middleware 225, either by including the TCP/IP address and/or port that the Middleware 225 was identified with, or by including a URL that will be resolved to the Middleware 225, or by any other method that can be captured by the Middleware 225.

In step 303 the web browser sends an HTTP request, for example a GET request, that is captured by the Middleware 225.

In step 304 the Middleware 225 partially processes the request, for example parses it, and forwards the original request or the processed request or a plurality of requests to the Agent 215 in the Web Server Emulation Device 210 for further processing.

In step 305 the Web Server Emulation Device 210 uses some data, for example a digital file stored in the hidden storage area, and optionally involving one or more Agents 215 to respond to the request, for example by sending a digital file together with some processed information back to the Middleware 225.

In step 306 the Middleware 225 processes the data received from the Web Server Emulation Device 210, for example adds an HTTP header and sends the complete response back to the web browsing application, for example in order to render a web page.

In the above exemplary flow chart, those skilled in the art may appreciate that the Client Digital Appliance 220 may or may not be connected to a network, such as the Internet. Furthermore, in some embodiments, the Middleware 225 may process the request without necessitating any processing from the Web Server Emulation Device 210, or without doing any processing prior to forwarding the request to the Web Server Emulation Device 210. In some embodiments, the Middleware 225 may receive requests from a remote computational device, such as a remote computer over a network.

According to some embodiments, the processing done by the Web Server Emulation Device 210 includes retrieval of a digital file from the hidden storage area. In other embodiments there is no data retrieval from the hidden storage area.

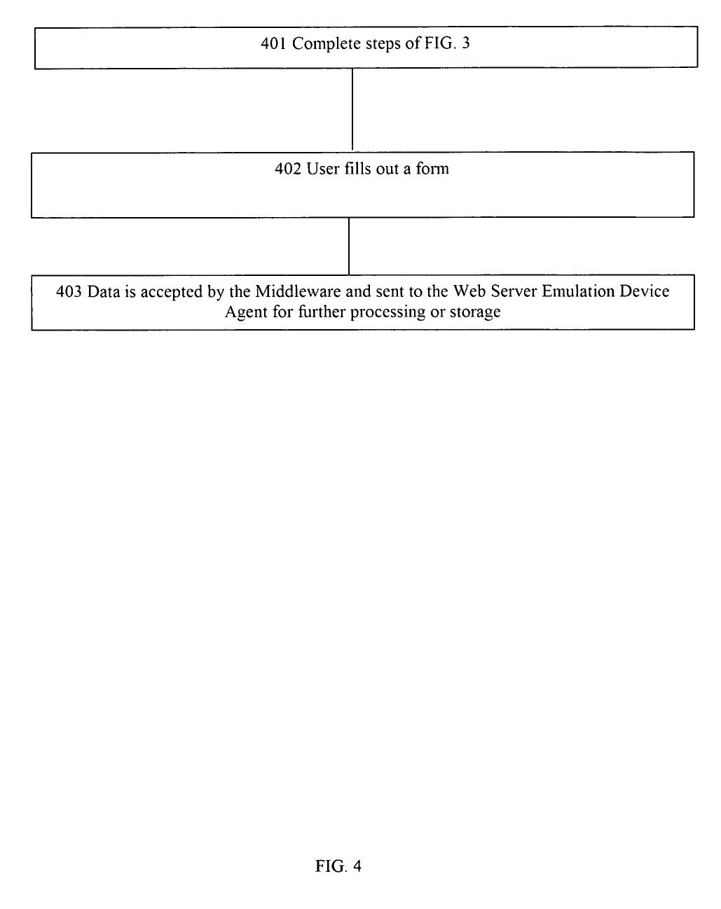

FIG. 4 is a flow chart describing an exemplary sequence of operations carried out when a user enters data to be stored on the Web Server Emulation Device 210. Step 401 completes the sequence of FIG. 3 in order to retrieve and render an input form.

In step 402 the user enters data to entries in the form.

In step 403 the data is sent to the Agent 215 through the Middleware 225. The Agent 215 may use the data for processing a response and/or storing the data in the non-volatile storage and/or manipulating the data in the form.

In other embodiments, the steps of FIG. 3 are not necessary, and it may not be required to retrieve the form from the Web Server Emulation Device 210 prior to accepting user inputs. In some embodiments, the Web Server Emulation Device 210 stores the user input in the user storage area or in the hidden storage area.

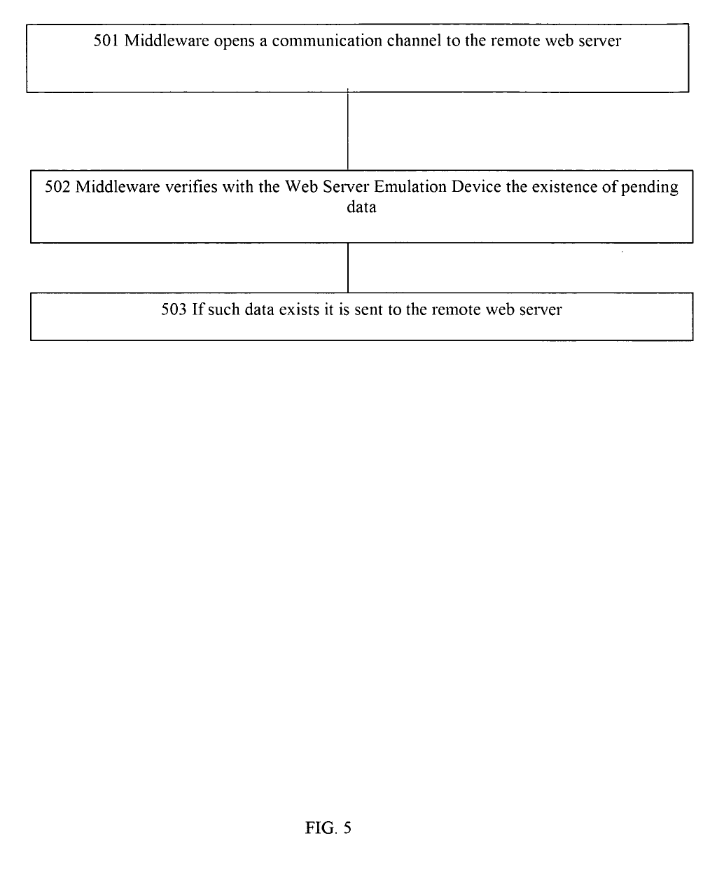

FIG. 5 is a flow chart describing an exemplary sequence of operations carried out when the user data is sent to a remote server. In step 501 the Middleware 225 opens a communication channel to a remote web server.

In step 502 the Middleware 225 verifies that there is user data stored on the Web Server Emulation Device 210.

In step 503 the Middleware 225 retrieves the user data from the Web Server Emulation Devices 210 and sends it over the network to the remote web server.

In some embodiments, the Middleware 225 first checks the availability of user data on the Web Server Emulation Device 210. In some embodiments a software program distinct from Middleware 225 initiates the communication to the remote web server, and uses the Middleware 225 to communicate with the Agent 215 in order to complete the transfer, the invention is not so limited.

In some embodiments the data on the Web Server Emulation Device 210 is encrypted or compressed by the Agent 215 prior being sent to the Middleware 225.

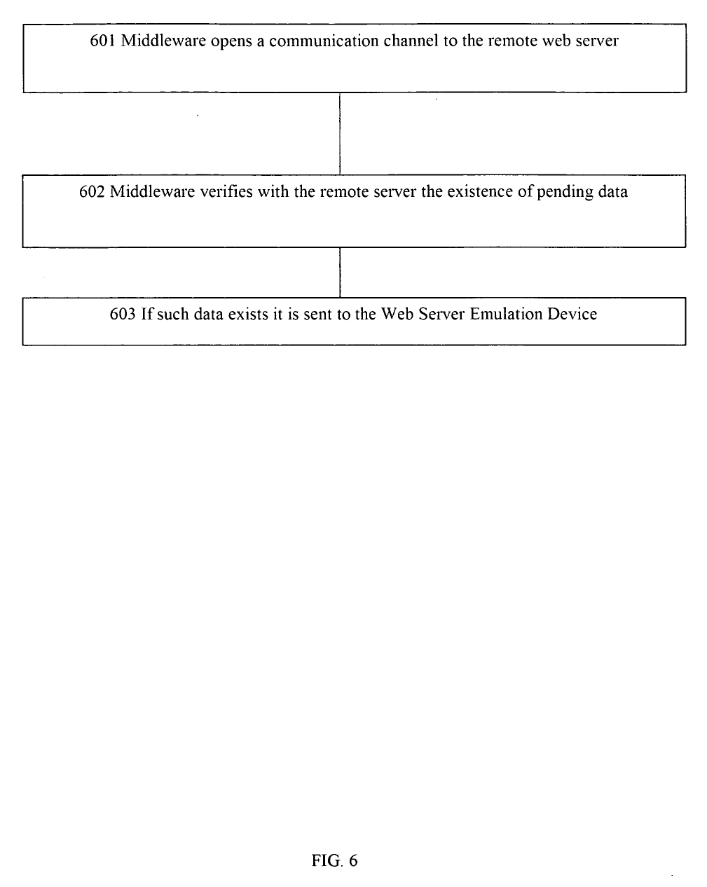

FIG. 6 is a flow chart describing an exemplary sequence of operations carried out when a remote server sends data to the Web Server Emulation Device 210. In step 601 the Middleware 225 opens a communication channel to a remote web server.

In step 602 the Middleware 225 verifies that there exist data from the remote web server for the Web Server Emulation Device 210.

In step 603 the Middleware 225 receives the data from the remote server and sends it to the Web Server Emulation Device 210.

In some embodiments, the Middleware 225 first checks the availability of data on the remote server, the invention is not so limited.

This exemplary sequence may be initiated automatically, for example every time a Web Server Emulation Device 210 is connected to a Client Digital Appliance 220 that is connected to a network, or initiated by user, the invention is not so limited.

In some embodiments, an authentication process may be executed as well. The authentication process ensures that data from the remote server reaches only the Web Server Emulation Device 210 intended.

1. A web server emulation device for serving web content, the web server emulation device adapted to be coupled to a digital appliance for end use of at least part of the web content, the web server emulation device comprising:
one or more non-volatile storages for storing at least part of the web content;
one or more interfaces, coupled to at least one of the nonvolatile storages, the one or more interfaces for receiving and sending at least part of the web content, and
one or more agents for preparing web content to be served the digital appliance,
wherein at least part of the web content is served to the to the digital appliance for end use of the web content.

2. The web server emulation device of claim 1, wherein the web server emulation device is coupled to the digital appliance.

3. The web server emulation device of claim 2, wherein the digital appliance is a computer.

4. The web server emulation device of claim 2, wherein the digital appliance is a personal digital assistant.

5. The web server emulation device of claim 2, wherein the digital appliance is a mobile phone.

6. The web server emulation device of claim 1, wherein the web content is at least a web page.

7. The web server emulation device of claim 1, wherein the web content is at least streamed content.

8. The web server emulation device of claim 1, wherein the web content is at least an electronic book.

9. The web server emulation device of claim 1, wherein the web content is at least a document.

10. The web server emulation device of claim 1, wherein the web content is at least an HTML form.

11. The web server emulation device of claim 1, wherein the web content is at least a multimedia file.

12. The web server emulation device of claim 1, wherein the web server emulation device couples to the digital appliance via a physical connection to the digital appliance.

13. The web server emulation device of claim 12, wherein the physical connection includes one or more cables.

14. The web server emulation device of claim 1, wherein the web server emulation device couples to the digital appliance by directly physically connecting to the digital appliance.

15. The web server emulation device of claim 1, wherein the web server emulation device couples to the digital appliance by remotely connecting to the digital appliance.

16. The web server emulation device of claim 1, wherein the web server emulation device couples to the digital appliance by wirelessly connecting to the digital appliance.

17. The one or more non volatile storages of claim 1, further comprising a hidden-from-user storage area used to store at least part of the web content, wherein said one or more agents control access to the hidden-from-user storage area.

18. The web server emulation device of claim 2, wherein said one or more agents prepare web content to be served by using information received from the coupled digital appliance.

19. The web server emulation device of claim 2, wherein said one or more agents obtain web content from a remote server.

20. A web server emulation system for serving web content, comprising:
a web server emulation device for serving web content, the web server emulation device adapted to be coupled to a digital appliance for end use of at least part of the web content, the web server emulation device comprising:
one or more non-volatile storages for storing at least part of the web content;
one or more interfaces, coupled to at least one of the nonvolatile storages, the one or more interfaces for receiving and sending at least part of the web content, and
one or more agents for preparing web content to be served the digital appliance, and
a digital appliance for the end use of at least part of the web content,
wherein at least part of the web content is served the to the digital appliance for end use of the web content.

21. A method for serving web content using a web server emulation device, comprising:
preparing the web content to be served;
serving the web content from a web server emulation device to a coupled digital appliance;
wherein at least part of the web content is served the to the digital appliance for end use of the web content.
